(19) United States
(12) Patent Application Publication
(10) Pub. No.: US 2004/0255784 A1
(43) Pub. Date: Dec. 23, 2004

(54) Discharge electrode

(76) Inventor: Harry Johansson, Skelleftea (SE)

Correspondence Address: Mark P Stone, 25 Third Street, 4 th Floor, Stamford, CT, 06905, US

(21) Appl. No.: 10/496,383

(22) PCT Filed: Nov. 27, 2002
(86) PCT No.: PCT/SE02/02194

(30) Foreign Application Priority Data
Nov. 30, 2001 (SE) 0104042-7

(51) Int. Cl. B03C 3/41

(52) U.S. Cl. 96/95

(57) ABSTRACT

The present invention relates to a discharge electrode (1) 5 for use in an electrostatic precipitator in combination with one or more collecting electrodes, wherein the discharge electrode (1) has the form of a tubular element (2). The discharge electrode (1) includes electrode elements (3) that consist of tongues (4) bent out from the wall (5) of said 10 tubular element, said tongues also be bent upwards. The invention also relates to a method of producing the discharge electrode.

The present invention relates to a discharge electrode as defined in the preamble of claim 1, for use in at electrostatic precipitator.

Electrostatic precipitators are used, for instance to clean dust-laden gases deriving from different types of industrial plants, incinerating plants, and combustion plants.

An electrostatic precipitator also includes so called collecting electrodes, in addition to discharge electrodes. A potential difference is created between the discharge electrodes and the collecting electrodes with the aid of a voltage source, so as to generate an electric field in an area between said electrodes through which the dust-laden gas passes, wherewith the dust particles are caused primarily to settle on the collecting electrodes, so that the gas will be essentially clean of dust as it exits from the precipitator.

There is used preferably a D.C. voltage, wherewith it is endeavored to border on ar; electric spark-over, i.e. to obtain tine greatest possible electric field strength at which a glow discharge or coronas will be achieved, so as to obtain a maximum separation force on the individual dust particles and thereby achieve the best possible gas clearing effect.

It is desired to design the electrode element of the discharge electrode so that generation of a glow discharge or corona will be stimulated at the same time as corrosion attack is minimised and good mechanical stability is obtained. The design of the electrode element will, conveniently, also be such as to enable the discharge electrodes to be manufactured and handled in a rational fashion. It is also desired that the discharge electrodes will require the minimum of service and will be highly effective.

An object of the present invention is to provide a discharge electrode with which these desiderata are achieved, said object being realised with a discharge electrode that has the characteristic features set forth in the accompanying claims.

The design ard construction of the iventive discharge electrode is such as to impart thereto a high degree of efficiency and also an extremely good resistance to corrosion. The electrode is Mechanically stable, simple to install and requires the minimum of maintenance. The discharge electrode affords both technical and economical advantages.

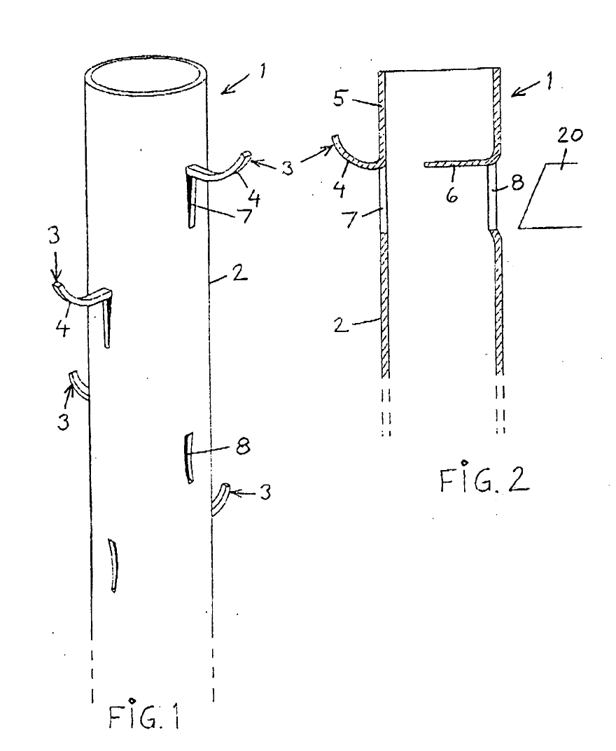

The invention will now be described in more detail with reference to an exemplifying embodiment thereof and also with reference to the accompanying drawing, in which FIG. 1 is a perspective view of an inventive discharge electrode, and FIG. 2 is a longitudinally sectioned view of the electrode shown in FIG. 1.

The illustrated discharge electrode 1 is constructed from a round tube 2 comprised of an electrically conductive material, for instance, of stainless steel or acid-proof steel, and includes e number of electrode elements or electrode tips 3 that have a corona stimulating function, among other things.

The electrode elements 3 consist in tongues or tabs 4 bent out from the wall of the tube 2. The tongue 4 is punched from the sell 5 of the tube 2 and bent outwards in the manner shown in FIGS. 1 and 2. Since the tab/tongue 4 is bent outwards, the tongue is punched out from inside the tube by using a punch tool 20, meaning that a tab or tongue 6 will also be punched cut on diametrically opposed sides of the tube, as will best be seen from FIG. 2. The tongue 6 is bent into the tube 2 and Roes not therefore constitute an outwardly projecting tongue.

As illustrated in the Figures, the tongues 4 are bent up at their respective tips, so as to ensure that water droplets, e.g. condensation, will not land on the tips of the electrode elements and therewith jeopardise their efficacy. The configuration of the tongues 4 and the sharpness of their edges provide significant advantages from the aspect of corona generation. The configuration of the tongue 4 also minimises the risk of dust build-up on the electrode elements 3, in accordance with the inventive concept.

Because the tongues/tabs 4 are punched from the tube wall 5, an opening 7 will be left in the wall immediately beneath a respective tongue 4 and a similar opening 8 will be left in the wall 5 beneath the inwardly facing tongue 6.

The discharge electrode 1 shown in FIG. 1 has a number of electrode elements 3 which point in four mutually different directions. It will be understood, however, that the number of electrode elements provided and their placement on the tube m may be varied as desired, in accordance with requirements. The cross-sectional shape of the tube 2 may also be different to that shown, and may, for example, be square instead of round.

It will also be understood that structural modifications are possible within the concept of the invention.

The invention is therefore not restricted to the illustrated and described embodiment thereof, since changes and modifications are possible within the scope of the accompanying claims.

1. A discharge electrode for use in an electrostatic precipitator in combination with one or more collecting electrodes, wherein the discharge electrode (1) is a tube (2), characterised in that the discharge electrode (1) includes electrode elements (3) that include a tab or a tongue (4) bent outwardly from the wall (5) of the tube (2), and in that the discharge electrode (1) includes a tab or a tongue (6) that is bent inwardly from the tube wall (5) and that is positioned generally diametrical to a corresponding outwardly bent tab or tongue (4).

2. A discharge electrode according to claim 1, characterised in that said outwardly bent tab or tongue (4) is also bent upwards.

3. A discharge electrode according to claim 1, characterised in that the wall (5) of the discharge electrode (1) includes an opening (7) in connection with each outwardly bent tab or tongue (4).

4. A method of manufacturing a discharge electrode according to claim 1, characterised by punching through the wall (5) of the tube (2) essentially diametrically with the aid of a punch (20) in one single working operation, such as to form tabs or tongues (4) that bend outwards from the tube wall material, said tabs or tongues (4) serving as electrode elements.

5. A discharge electrode according to claim 2, characterised in that the wall (5) of the discharge electrode (1) includes an opening (7) in connection with each outwardly bent tab or tongue (4).

6. A method of manufacturing a discharge electrode according to claim 2, characterised by punching through the wall (5) of the tube (2) essentially diametrically with the aid of a punch (20) in one single working operation, such as to form tabs or tongues (4) that bend outwards from the tube wall material, said tabs or tongues (4) serving as electrode elements.

7. A method of manufacturing a discharge electrode according to claim 3, characterised by punching through the wall (5) of the tube (2) essentially diametrically with the aid of a punch (20) in one single working operation, such as to form tabs or tongues (4) that bend outwards from the tube wall material, said tabs or tongues (4) serving as electrode elements.

8. A method of manufacturing a discharge electrode according to claim 5, characterised by punching through the wall (5) of the tube (2) essentially diametrically with the aid of a punch (20) in one single working operation, such as to form tabs or tongues (4) that bend outwards from the tube wall material, said tabs or tongues (4) serving as electrode elements.
